(19) United States
(12) Patent Application Publication
(10) Pub. No.: US 2004/0179140 A1
(43) Pub. Date: Sep. 16, 2004

(54) Method for saw-tooth removal of de-interlaced images using expanding window search

(76) Inventors: Chao-Chee Ku, Hsin-Chu (TW); Kuan Liang, Hsin-Chu (TW)

Correspondence Address: ANTHONY R BARKUME, 20 GATEWAY LANE, MANORVILLE, NY, 11949, US

(21) Appl. No.: 10/757,045

(22) Filed: Jan. 14, 2004

(30) Foreign Application Priority Data
Mar. 13, 2003 (TW) 092105532

(51) Int. Cl. H04N 5/21

(52) U.S. Cl. 348/625

(57) ABSTRACT

A method for saw-tooth removal of de-interlaced images using expanding window search obtains a target by image signals of three fields comprising steps of: processing a first judgment procedure for determining a targeted image having a possible edge according to the image signals of the three fields; processing an expanding window search according to the targeted images having the possible edge; and processing a second judgment procedure according to the result of the expanding window search to distinguish a true edge from the targeted images having the possible edge in order to obtain the target.

### FIELD OF THE INVENTION

The present invention is related to a method for saw-tooth removal of de-interlaced images using expanding window search, and more particularly to offer the image signals of three fields to find the target. The feature is to search the edges of the targeted image to remove the oblique angle saw-tooth of de-interlaced images.

### BACKGROUND OF THE INVENTION

Generally, the image signals of TV and DVD films are interlaced, but not progressive like computer screen. Interlaced scanning is divided into two fields, the odd scan lines form a field and the evens one form another. The common TV displays the image signals on the screen by the two fields, but when using CRT, the electron beams shoot on the phosphorus. So that two pixels will overlap while displaying, and if the objects have some saw-tooth, they will be dim and look smoother because of the persistence vision. As the result of the reacting time to human vision, the flicker of display screen is not so obvious at a fixed distance (The vision of human is much more sensitive to a large area flicker than a small one.).

For the technological progression of digital systems and flat panel displays (Such as LCD), flat panel TV will become more popular. Because the material of flat panel displays like LCD is liquid crystal, the difference between LCD and CRT are obvious (such as reactive time and two pixels can't overlap while displaying). If there are artifacts such as saw-tooth, serration, judder while displaying, and when we compare LCD with CRT, the result will be more obvious. And because of growing of screen size, so that the defects will be amplified. For getting better display quality, TV image signals can't display on the screen without processing. Anyway, a robust de-interlacer is necessary and important in the current TV image domain.

The normal de-interlace of the moving images for edge preserving, we often use median interpolation. But the method can't detect the orientations so we can't fix the directions images moved. Consequently, the high spatial frequency images are easy to flicker and only suit the low spatial frequency images.

While the video plays, because of the uncertain characteristics of the moving images with the oblique angle saw-tooth of de-interlaced image, if it can't be fixed properly, the saw-tooth will be more obvious on the screen. Therefore, for getting better images quality output, we have to process every image individually.

FIG. 1 shows a prior art of the individual de-interlace for different image characteristics. As shown in the figure, step 20 determines the static images then step 21 processes the de-interlace of static images with Inter-field Average. Step 30 is used to determine those slow-moving images then the inter-/intra-field interpolation of step 31 is used to de-interlace the slow-moving images. Finally, step 10 is used to determine the fast-moving images, but how to de-interlace the images for better quality is the future objective of the skilled in the art.

### SUMMARY OF THE INVENTION

An objective of the present invention is to remove the oblique angle saw-tooth of a de-interlaced image effectively.

Another objective of the present invention is to utilize the expanding window search method to remove the oblique angle saw-tooth of a de-interlaced image.

Another objective of the present invention is to offer image signals of three fields for processing the expanding window search on the targeted images with possible edges.

Another objective of the present invention is to use the results of the expanding window search for adjusting whether if the targeted images have edges or not to obtain the target.

Another objective of the present invention is to remove the oblique angle saw-tooth of de-interlaced images to obtain a better image quality output.

According to the present invention, a method for saw-tooth removal of de-interlaced images using expanding window search obtains a target by image signals of three fields comprising steps of:

processing a first judgment procedure for determining a targeted image having a possible edge according to the image signals of the three fields;

processing an expanding window search according to the targeted image having the possible edge;

processing a second judgment procedure according to the result of the expanding window search to distinguish a true edge from the targeted image having the possible edge in order to obtain the target.

In accordance with one aspect of the present invention, the first judgment procedure includes a determination criterion of (|C₋₁-D₁|≧ζ₁) & (|D₋₁-C₁|≧ζ₁) & (|C-D|≧ζ₁) & (|C-D₋₁|≧ζ₁) & (|C-D₁|≧ζ₁) & (|D-C₋₁|≧ζ₁) & (|D-C₁|≧ζ₁), where the C, C₁, D, D₁ are the adjacent points of the targets and ζ₁ is a threshold value.

In accordance with one aspect of the present invention, a search range is set on the expanding window search, and according to the search range, a plurality of expanding windows are selected to determine the targeted image of the possible edge is able to have a right edge.

In accordance with one aspect of the present invention, according to the search range, the expanding windows are selected to determine the targeted image of the possible edge is able to have a left edge.

In accordance with one aspect of the present invention, the second procedure comprises steps of:

processing a right-edge mask product according to the maximal value of a right edge determination series; and

processing a left-edge mask product according to the maximal value of a left edge determination series.

In accordance with one aspect of the present invention, the right edge determination series is obtained according to the expanding windows.

In accordance with one aspect of the present invention, the left edge determination series is obtained according to the expanding windows.

The present invention may best be understood through the following description with reference to the accompanying drawings, in which:

### BRIEF DESCRIPTION OF THE DRAWINGS

FIG. 1 shows a prior art of different de-interlace procedures for individual image characteristics;

FIG. 2 shows a preferred embodiment for removing the saw-tooth of de-interlaced images by using expand window search;

FIG. 3 shows a preferred flowchart according to the invention;

FIG. 4 shows the procedure of step 102;

FIG. 5 shows the procedure of step 103;

FIG. 6 shows the procedure of step 1034;

FIG. 7 shows the procedure of step 1035;

FIG. 8 shows the procedure of step 106;

FIG. 9 shows the procedure of step 1062;

FIG. 10 shows the procedure of step 1064;

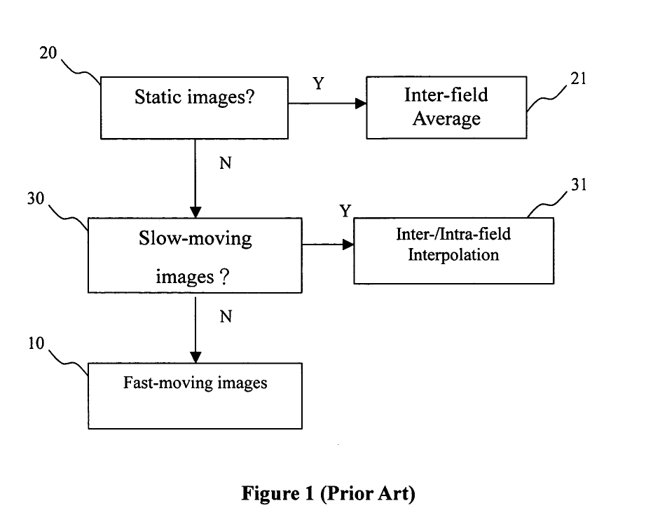

### DETAILED DESCRIPTION OF THE PREFERRED EMBODIMENT

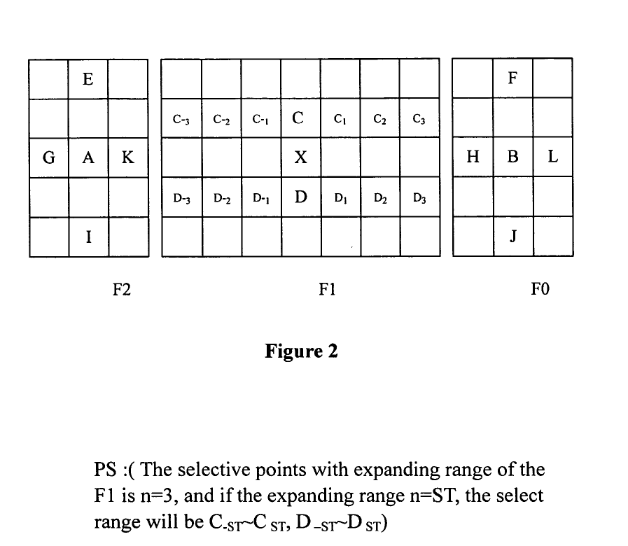

FIG. 2 shows a preferred embodiment for removing the saw-tooth of de-interlaced images by using expand window search. The three required fields, F0, F1, and, F2 for de-interlace are temporarily saved in the frame buffer, where the target X and other adjacent points C₋₃, C₋₂, C₋₁, C, C₁, C₂, C₃, D₋₃, D₋₂, D₋₁, D, D₁, D₂, D₃ (under the condition that n=3, and if the expanding range n=ST, the selective range will be C_{-ST}˜C_{ST},D_{-ST}˜D_{ST}) are in the field F1, the adjacent points A, E, G, I, K are in the field F2 in front of the F, and the adjacent points, B, F, H, J, L are in the field F0 in back of the field F1.

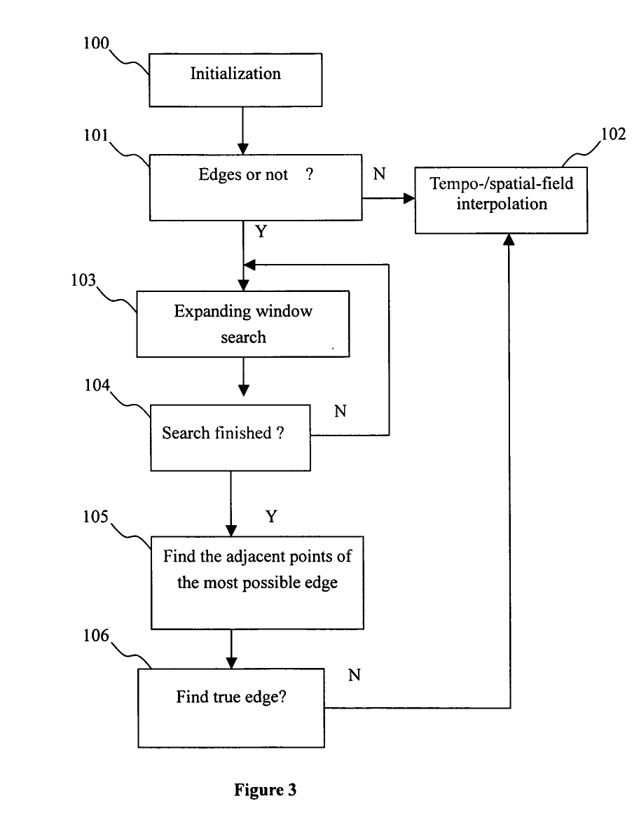

FIG. 3 is a preferred flowchart according to the invention, comprising step of:

Step 100: The initialization of some parameters:

ED_VR=ED_VL=ones (1, SR)

DsCR=DsCL=DsDR=DsDL=ones (1, SR)

MaxDsCR=MaxDsCL=MaxDsDR=MaxDsDL=zeros (1, SR)

Select the mask matrix:

$$ED\_maskR = [ \begin{matrix}- 1 & - 1 & 2 \\ 2 & - 1 & - 1\end{matrix} ]$$

$$ED\_maskL = [ \begin{matrix}2 & - 1 & - 1 \\ - 1 & - 1 & 2\end{matrix} ]$$

$$EW\_maskR = [ \begin{matrix}0 & 0 & 1 \\ 1 & 0 & 0\end{matrix} ]$$

$$EW\_maskL = [ \begin{matrix}1 & 0 & 0 \\ 0 & 0 & 1\end{matrix} ]$$

Step 101: the first judgment procedure. We can use the creterion

(|C₋₁-D₁|≧ζ₁) & (|D₋₁-C₁|≧ζ₁) & (|C-D|≧ζ₁) & (|C-D₋₁≧ζ₁) & (|C-D₁|≧ζ₁) & (|D-C₋₁|≧ζ₁) & (|D-C₁|≧ζ₁)

to determine the fields possibly have an edge in the frame buffer. If there is possibly an edge, go to step 103. Otherwise go to step 102 for processing tempo-/spatial-field interpolation.

Step 102 : Process Tempo-/Spatial-field Interpolation.

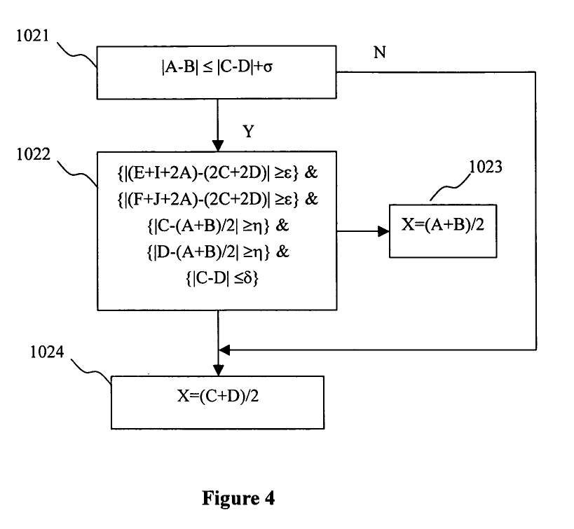

Select a tempo-field or a spatial-field interpolation judgment criteria. please refer to the FIG. 4 of step 1021. The equation |A-B|<=|C-D|+σ, is used to determine the tempo-field (A, B) or the spatial-field (C, D) have higher correlation. Here the positive value σ at the right of the equation avoid the misjudgment on the occasion of |A-B|=|C-D|. When step 1021 is not satisfied, go to step 1024 to process spatial-field interpolation. Otherwise go to step 1022 for further estimation. When the condition of step 1022 is satisfied, go to step 1023 directly to process tempo-field interpolation. Otherwise go to step 1024 to process spatial-field interpolation.

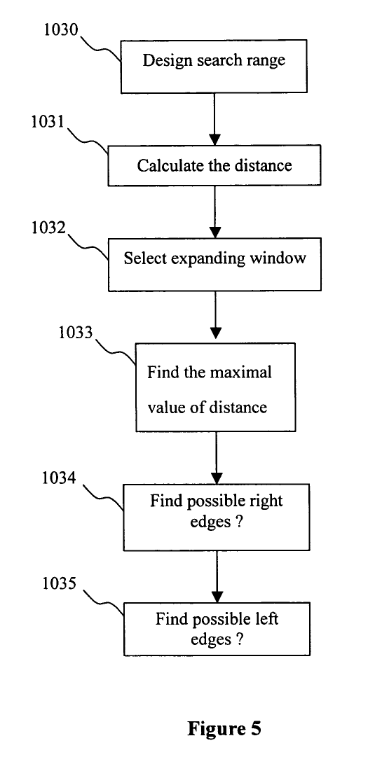

Step 103: process expanding window search, please refer to FIG. 5.

Step 1030: set a search range, let ST=2 to SR.

Step 1031: calculate the distance of each adjacent point.

DsCL(ST)=|C_{-ST}-C_{-(ST-1)}|

DsCR(ST)=|C_{ST}-C_{(ST-1)}|

DsDL(ST)=|D_{-ST}-D_{-(ST-1)}|

DsDR(ST)=|D_{ST}-D_{(ST-1)}|

Step 1032: select the current expanding window.

$$ED\_PY ( ST ) = [ \begin{matrix}{C}_{- ST} & C & {C}_{ST} \\ {D}_{- ST} & D & {D}_{ST}\end{matrix} ]$$

Step 1033: find the maximal distance of every adjacent point

MaxDsCL(ST)=max [DsCL(1:ST)]

MaxDsCR(ST)=max [DsCR(1:ST)]

MaxDsDL(ST)=max [DsDL(1:ST)]

MaxDsDR(ST)=max [DsDR(1:ST)]

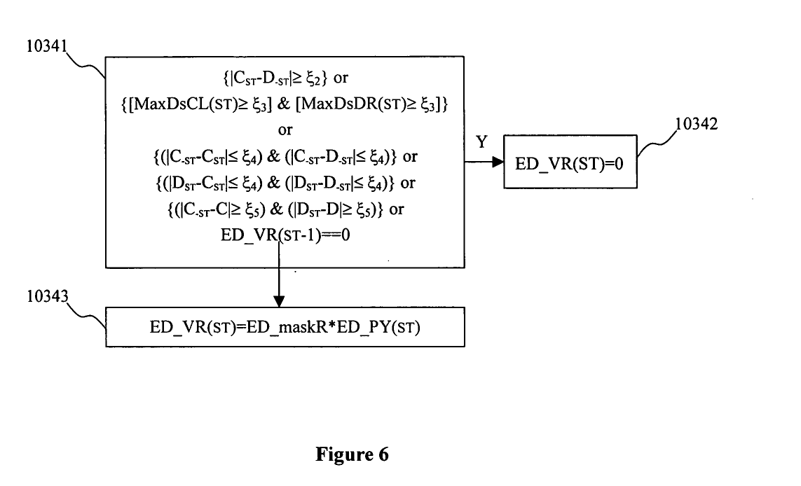

Step 1034: determine whether if the fields in the frame buffer have a possible right edge or not, and calculate the right edge determination series value ED_VR (ST) of the current expanding window. Please refer to the procedure of steps 10341, 10342, and 10343 in FIG. 6.

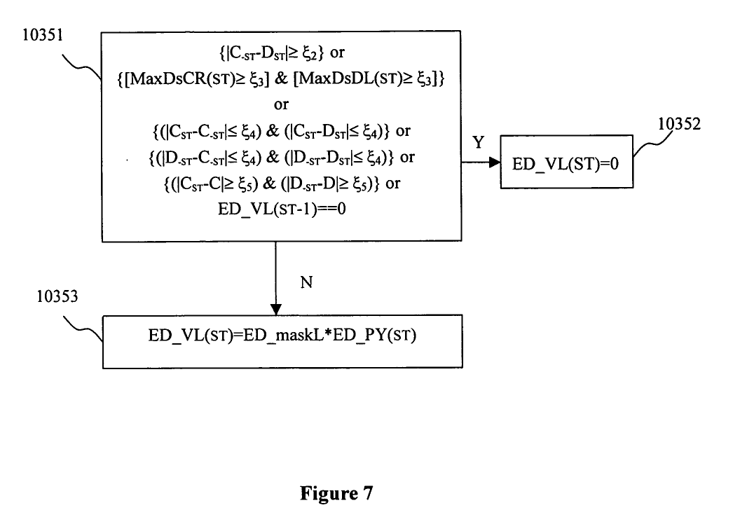

Step 1035: determine whether if the fields in the frame buffer have a possible left edge or not, and calculate the left edge determination series value ED_VR (ST) of the current expanding window. Please refer to the procedure of steps 10351, 10352, and 10353 in FIG. 7.

Step 104: determine the search is over (if ST equal to SR). When ST doesn't equal to SR, let ST:=ST+1 and back to step 103, and go to step 105 while ST=SR.

Step 105: find the adjacent points for the most possible edge.

EDR=find {ED_VR==max (ED_VR)}

EDL=find {ED_VL==max (ED_VL)}

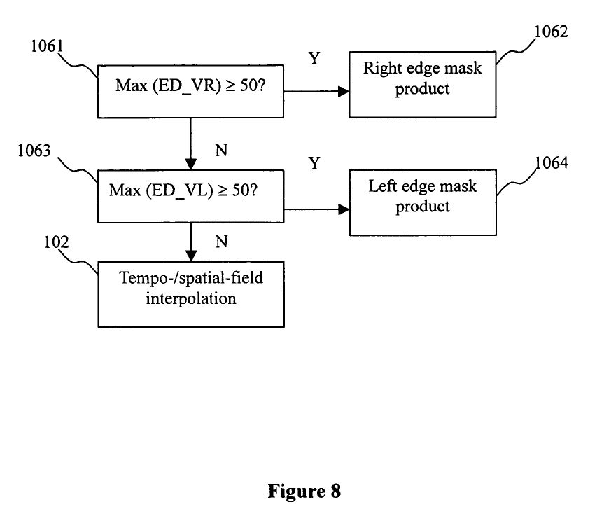

Step 106 is the second judgment procedure. Determine a true edge from the possible edges of the field in the frame buffer. Please refer to procedure of the FIG. 8:

Step 1061: determine whether if the maximal value (ED_VR) of the right edge determination series is more than a default threshold (for example 50) or not. If true, go to step 1062 to process the right-edge mask product. Otherwise go to step 1063 to continue further determination.

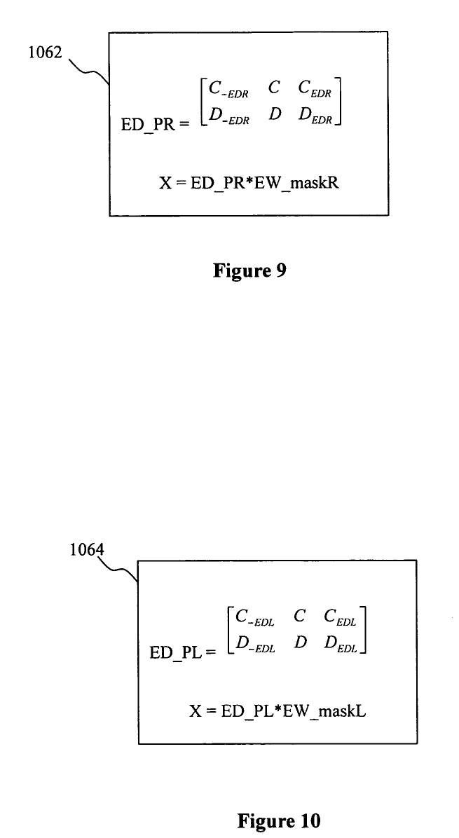

Step 1062: please refer to the FIG. 9. Process the right-edge mask product to find the target X.

Step 1063: determine whether if the maximal value (ED_VR) of the right edge determination series is more than the default threshold. If true, go to step 1064 to process the left-edge mask product. Otherwise go to step 102 to process tempo-/spatial-field interpolation.

Step 1064: please refer to the FIG. 10. Process the left-edge mask product to find the target X.

The invention is used to improve the conventional technology and process expanding window search for the targeted image with possible edges. Then we use the outcome of expanding window search to determine the targeted image have edges to obtain the target X. The advantage is precisely to detect the low angle line and more oblique image edges in de-interlacing, so that we can remove the saw-tooth of de-interlaced images effectively and obtain a preferred image output

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for saw-tooth removal of de-interlaced images using expanding window search for obtaining a target by image signals of three fields comprising steps of:
processing a first judgment procedure for determining a targeted image having a possible edge according to said image signals of said three fields;
processing an expanding window search according to said targeted image having said possible edge;
processing a second judgment procedure according to the result of said expanding window search to distinguish a true edge from said targeted image having said possible edge in order to obtain a target.

2. The method according to claim 1 wherein said first judgment procedure includes a determination criterion of (|C₋₁-D₁|≧ζ₁) & (|D₋₁-C₁|≧ζ₁) & (|C-D|≧ζ₁) & (|C-D_{-1|≧ζ}₁) & (|C-D₁|≧ζ₁) & (|D-C₁|≧ζ₁) & (|D-C₁|≧ζ₁), where the C, C₁, D, D₁ are the adjacent points of said target and ζ₁ is a threshold value.

3. The method according to claim 1 wherein a search range is set on said expanding window search, and according to said search range, a plurality of expanding windows are selected to determine said targeted images of said possible edge is able to have a right edge.

4. The method according to claim 3 wherein according to said search range, said expanding windows are selected to determine said targeted images of said possible edge is able to have a left edge.

5. The method according to claim 4 wherein said second procedure comprises steps of:
processing a right-edge mask product according to the maximal value of a right edge determination series; and
processing a left-edge mask product according to the maximal value of a left edge determination series.

6. The method according to claim 5 wherein said right edge determination series is obtained according to said expanding windows.

7. The method according to claim 5 wherein said left edge determination series is obtained according to said expanding windows.
